(19) United States
(12) Patent Application Publication
(10) Pub. No.: US 2018/0157897 A1
(43) Pub. Date: Jun. 7, 2018

(54) Photo Link

(71) Applicant: Shedrick Terrell Cunningham, Anniston, AL (US)

(72) Inventor: Shedrick Terrell Cunningham, Anniston, AL (US)

(21) Appl. No.: 15/530,162

(22) Filed: Dec. 2, 2016

(51) Int. Cl. G06K 9/00; H04L 12/18

(52) U.S. Cl. CPC G06K 9/00288; H04L 12/1895

(57) ABSTRACT

The idea is to create a computer based application that uses facial recognition technology to detect and alert it users when photo(s)/video(s) with the user's facial likeness are taken and shared via social network/internet.

The user(s) of photo link doesn't have to be connected with a circle of friends or community to be notified of their facial likeness in photo(s)/video(s) being shared/used. The alerts will contain content exactly as the content is being shared including text, audio, emoji's, ect.

Photo link also allows its users to contact other users based on photograph(s). The facial recognition software can generate images of other users that closely resemble the likeness of other users which will result in finding people who resemble each other, therefore people will be able to find and contact their look-a-like/twin.

Photo link is a biometric database that sorts images based on the unique characteristics of each user. Photo link assigns the image(s) to user(s) by name through email address and or cell phone number(s) of that user's account.

Photo link's biometric database will:
store and sort images according to biometric make up and user(s) account(s).
inform users when image(s) with unique characteristics of that user is/are entered into photo link's data base.
allow user(s) to enter image(s)/photograph(s) of other user(s) to contact/communicate with that user by message(s). (Email, text, and or audio conversation)
allow user(s) to see and contact other user(s) with similar unique facial characteristics to of any user's image including one's self image.

1. Facial recognition technology is used to automatically inform user(s) of image(s)/video(s) with facial likeness to theirs being used and or shared with or without use of manual tags (via message/alert). The message/alert will provide user(s) with exact content being shared.

2. Facial recognition technology is used to send message(s) to desired person(s) through email/established electronic linked address without having to be in an established group, circle, or community of friends. Messages can be sent by using only a photo of the person(s) that the message is intended to reach.

3. Facial recognition technology is used to contact other people/person(s)/user(s) with facial features similar to one's own facial features, this results in user(s) being able to find and contact their look-a-like/twin.
